(19) United States
(12) Patent Application Publication
(10) Pub. No.: US 2010/0068688 A1
(43) Pub. Date: Mar. 18, 2010

(54) MANAGEMENT OF TEACHING PROCESSES FOR INDIVIDUALIZED INSTRUCTION IN A MULTISTUDENT ENVIRONMENT

(76) Inventor: Howard Shapiro, Santa Fe, NM (US)

Correspondence Address: FRANKLIN & ASSOCIATES INTERNATIONAL LLC, 230 St. Francis Drive, Suite 1, SANTA FE, NM, 87501, US

(21) Appl. No.: 12/513,645

(22) PCT Filed: Nov. 6, 2006
(86) PCT No.: PCT/US06/60579

§ 371 Date: May 5, 2009

(51) Int. Cl. G09B 3/00

(52) U.S. Cl. 434/350

(57) ABSTRACT

A system and a method are described for managing the process of simultaneously teaching a large number of students, who have a widely varying range of skills in a content area, by using individualized instruction. The system and the method achieve this by allowing the teacher's resources to be utilized more efficiently, which makes the teaching more effective. In addition, it allows the teacher to determine the mastery criteria and the scope and sequence of a content area. Students accelerate through a sequence of skills determined by the teacher using their prior knowledge until they encounter a skill deficiency. Pre- and post-testing is used in conjunction with highly-focused, individualized instruction, in a feedback-loop-cycle until the student masters the specific skill. The system and the method are applicable to any subject area where learning is enhanced by a sequential learning process.

### BACKGROUND OF THE INVENTION

1. Technical Field of the Invention

A system and a method of managing the process of simultaneously teaching a large number of students, who have a widely varying range of skills in a content area, using individualized instruction.

2. Description of the Prior Art

Leading educators from inner city schools and schools servicing lower socio-economic student populations report that their classes contain a large number of students with a widely varying range of skills in a content area. These circumstances are not limited to those school systems mentioned. In addition, the skill profiles for students working at comparable grade levels are likely to be different because they do not have exactly the same skill deficiencies. In any of these cases, whole group instruction is rendered ineffective. This is especially true for subjects like math, where skills must be mastered sequentially in order for students to learn higher concepts.

Traditionally, teachers use individualized instruction to remediate students who have skill deficiencies. This method of tutoring students is impractical in a classroom setting. The problem is exacerbated by the teacher's obligation, especially today with stricter state requirements, to move through a prescribed scope and sequence for those students who are able to progress through the curriculum. In addition, traditional whole group instruction often does not ensure that the student achieves mastery of a skill before they progress through the curriculum. Unless the student receives tutoring, the extent of their skill deficiencies will continue to grow, which makes it increasingly difficult to accommodate their learning needs in the classroom setting. In effect, the need existed to develop a system and a method for teachers to implement individualized instruction within the multi-student classroom setting.

U.S. Pat. No. 6,609,712 for a math manipulative educational learning game in which a plurality of rods are provided for use in various manipulative games designed to teach rudimentary arithmetic skills. In the preferred embodiment, the rods are of various lengths and/or volumes, with the shortest length comprising a unit length, and other rods being formed in integral multiples of the unit length. Various games are disclosed in which a child is encouraged to manipulate the rods in various ways and in order to learn various arithmetic lessons. For example, in one game a Game Master selects any of the rods except the rod having unit length and places it upon a game playing surface. Thereafter, the Partner must select a plurality of rods whose combined lengths equal the length of the rod played by the Game Master. These rods are laid end-to-end along side the rod played by the Game Master in order to demonstrate their length equality. The Game Master then selects another rod other than the rod of unit length and lays the second rod end-to-end with the first rod which the Game Master played. The Partner is again required to select a plurality of rods to whose combined lengths, when placed end-to-end with the rods already played by the Partner, equal the length of the rods played by the Game Master. The play continues in this manner until no more moves may be made from the selection of rods remaining. Other manipulative games are also disclosed.

This patent applies only to rudimentary math skills whereas the proposed system and method apply to a wide range of math skills. In addition, the proposed system and method utilize existing techniques to enable the teacher to be more effective and efficient, especially in an environment where students have a widely varying range of skills in one class.

U.S. Pat. No. 6,922,710 for Hand-held calculator with problems and operations linked lists. A hand-held calculator programmed to teach mathematics in a manner which emulates traditional step-by-step teacher-student teaching methods and shows the important intermediate steps. Using linked lists, the method allows the use of selected data sets of problems and provides choices of mathematical operations, including transformations which are applicable or can operate on a selected problem. Importantly, the choices available to the student will not always lead to a solution or simplification of the problem. This allows the student to see the effect of an improper choice, as well as a proper choice.

This patent applies only to rudimentary math skills whereas the proposed system and method apply to a wide range of math skills. In addition, the proposed system and method utilize existing techniques to enable the teacher to be more effective and efficient, especially in an environment where students have a widely varying range of skills in one class.

U.S. Pat. No. 6,811,401 for a Binary rotation teaching game. The game for teaching binary mathematics includes a plurality of balls, a backboard, and a plurality of elongate members selectively connected to each other and to the backboard in non-horizontal directions. A plurality of gate sections are pivotally connected to the backboard and engageable with select ones of the plurality of members so that the gate sections can be pivoted between open and closed positions respectively. Select ones of the plurality of balls may cause corresponding ones of the plurality of gate sections to pivot between open and closed positions after passing thereby. Corresponding 0 and 1 binary values are assigned to closed and open ones of the plurality of gate sections, respectively, so that a number of the plurality of marbles that have been introduced to the game can be determined by adding the corresponding 0 and 1 binary values.

This patent applies only to a game to teach binary mathematics whereas the proposed system and method apply to a wide range of math skills. In addition, the proposed system and method utilize existing techniques to enable the teacher to be more effective and efficient, especially in an environment where students have a widely varying range of skills in one class.

U.S. Pat. No. 6,648,648 for a Instructional mathematics board game. An educational game for teaching mathematics has a game board with a continuous play path along its edge. Spaces are labeled with a mathematical category and a monetary amount. Each mathematical category has its own deck of cards with questions, answers and explanations. At least one of the spaces of the game board is labeled with the help category. When a player lands on this space they receive a help card, which permits that player to ask another player for help in solving a question. The game is played by moving a marker along the play path. If the marker stops on a space that has a mathematical category the player selects corresponding card. If the player's solution to the question and answer on the card match the player collects play money in the amount printed on the space. If not, play proceeds to the next player and the first player continues to work on the question, giving that player the ability to self-correct. All solutions may be collected as an assignment by a teacher in a classroom setting. The first player to accumulate a specified amount of play money is the winner.

This patent applies only to a game to teach binary mathematics whereas the proposed system and method apply to a wide range of math skills. In addition, the proposed system and method utilize existing techniques to enable the teacher to be more effective and efficient, especially in an environment where students have a widely varying range of skills in one class.

U.S. Pat. No. 6,513,708 for a mathematics teaching system. A mathematics teaching system for visually and physically teaching a student how to perform multiplication and division calculations in a simple to understand format. The mathematics teaching system includes a housing having a plurality of apertures aligned in vertical and horizontal rows, an upper opening within the housing for inserting tokens into, a lower opening for allowing tokens to escape, a vertical slot and a horizontal slot within the housing for receiving slider members, a plurality of vertical reference numerals and a plurality of horizontal reference numerals, and a stopper member slidably positioned within a lower portion of the housing for retaining the tokens in a desired location for allowing calculation by a student.

This patent applies only to system for visually and physically teaching a student how to perform multiplication and division calculations whereas the proposed system and method apply to a wide range of math skills. In addition, the proposed system and method utilize existing techniques to enable the teacher to be more effective and efficient, especially in an environment where students have a widely varying range of skills in one class.

U.S. Pat. No. 5,571,019 for a Apparatus and method for teaching concepts of mathematics. A system for teaching the basic concepts of mathematics utilizing a ball or the like having situated thereon certain mathematical problems and solutions, each such problem having framed thereabout certain colored geometric symbols, the symbols indicating certain commonalities in the problem. The ball of the present invention is to be utilized in organized or unorganized play, and is configured in such a manner as to relay to the user certain basic themes associated with mathematics, including (but not limited to) addition, subtraction, multiplication, and division. The preferred embodiment of the present invention teaches a generally spherical ball having multiple diverse geometric configurations, each like configuration having a common mathematical type of problem thereon, as well as a common color. In the preferred embodiment, the configurations could be situated randomly across the surface of the ball, or could be arranged along the longitudinal and/or latitudinal axis of the ball. In play, the user would, for example, bounce the ball, or otherwise cause randomized movement of the surface of the ball, catch or retrieve the ball, and lift the ball in to view, focusing on the geometric configuration within the nearest view of the user, and recite the problem to himself/herself; in the alternative, the user could recite the problem out loud to a playmate, withholding the answer so that the playmate can attempt to answer same. The geometric configurations could be raised on the ball to increase randomization during bouncing, while providing a tactile surface to stimulate the user.

This patent applies only to system for teaching a student the basic concepts of mathematics whereas the proposed system and method apply to a wide range of math skills. In addition, the proposed system and method utilize existing techniques to enable the teacher to be more effective and efficient, especially in an environment where students have a widely varying range of skills in one class.

U.S. Pat. No. 5,649,826 for a Method and device for teaching language. A method and device for teaching a given language to one or more users in an entertaining manner is provided utilizing a media series for teaching a given language to one or more users, particularly young children. The media series contains the given language as well as language other than the given language and is made up of series lessons which sequentially contain an increasing percentage of the given language. A user is progressively exposed to the media series by exposing the user to the series lessons in sequential fashion beginning with a first series lesson containing a lowest percentage of the given language and ending with a last series lesson containing a highest percentage of the given language. The given language to be learned is utilized and presented strategically such that the meaning of the given language can be readily and intuitively understood and wherein no supervision is necessary.

The only similarity with this patent and the proposed system and method is that there is a sequential fashion to the lessons. The method and device for teaching language does not assess prior knowledge of the student. Therefore, the lessons do not target student skill deficiencies. The proposed system and method utilize existing techniques to enable the teacher to be more effective and efficient, especially in an environment where students have a widely varying range of skills in one class.

U.S. Pat. No. 5,139,423 for a Electronic teaching device. An electronic teaching device (10) provides several mathematical activities including Place Value, Trade, Target, Solve It, Word Problems, Estimate, Select and Calculator. The Place Value activity enhances the understanding of numbers by pictorially displaying the place values. The Trade activity enhances the understanding of addition and subtraction by allowing the user to trade between the ones' place value and the tens' place value to properly perform a mathematical operation. The Target activity emphasizes logical reasoning and problem solving. The Solve It activity uses the place-value system to develop logical reasoning. The Word Problems activity tests the user's knowledge of basic mathematical terms and facts. The Estimate activity develops the ability to estimate answers to problems. The Select activity allows the user to recognize basic math operations.

This patent applies only to an electronic teaching device as compared to a system and method of diagnosing and identifying the specific skills a student does not have mastery of, which then allows teaching to be directed to those skills. In addition, the proposed system and method utilize existing techniques to enable the teacher to be more effective and efficient, especially in an environment where students have a widely varying range of skills in one class.

U.S. Patent application publication number 20040219502 for a system for assessment of a subject is disclosed, that system having: a first test item, at least one subject response elicited from the subject by the first test item; a reference response corresponding to the first test item, to which the at least one subject response is compared; a means for providing to the subject predetermined assistance corresponding to the first test item if the subject response to the first test item is not equal to the reference response, that assistance eliciting a further subject response; and a second test item selected as a function of the number of subject responses elicited until the subject response matches the reference response. The test items may be hierarchically related based on cognitive learning theory in a content area.

This patent applies only to a system of assessment of a subject. The system does not then provide a method to allow the teacher to easily teach to the specific content area identified by the assessment tool so as to ensure that the student achieves mastery in that specific content. In addition, the proposed system and method utilize existing techniques to enable the teacher to be more effective and efficient, especially in an environment where students have a widely varying range of skills in one class.

### SUMMARY OF THE INVENTION

The applicant has actually reduced the present invention to practice by teaching a seventh grade math class in accordance with the described system and method, which may be found in the DETAILED DESCRIPTION OF THE INVENTION. The system and a method are used in managing the process of simultaneously teaching a large number of students, who have a widely varying range of skills in a content area, using individualized instruction. Hence, the system and the method accommodate a student population with a vast number of unique skill profiles who enter the system at any point in time.

It allows them to accelerate through previously mastered concepts in a prescribed sequence until they encounter a skill deficiency. These deficiencies are diagnosed by the system and method and are treated with highly-focused, individualized instruction. Pre- and post-testing are used in conjunction with the instruction in a feedback-loop-cycle until the student masters the specific skill.

At any point in the prescribed sequence, the rate of progress for each student is dependent on their unique skill profile. However, it is independent of the rate of progress of other students, which allows for self-paced study. In addition, the system and method accommodate the introduction of new students into the system at any point in time during the school year.

The system and method allow the scope and sequence of the curriculum to be aligned with the content standards of the subject area. One application of the system and method is to prescribe a sequence of skills which are aligned with the Northwest Evaluation and Assessment's (NWEA) scope and sequence for the purpose of teaching mathematics. This has been successfully applied by the inventor in a seventh grade math class.

The students are assessed on each skill in the sequence, which provides instant feedback to the student and the teacher. Therefore, when they demonstrate mastery of a skill they receive positive reinforcement, which motivates them to tackle the next skill test with a positive attitude. However, when the student encounters a skill deficiency the students' misconceptions are promptly addressed with individualized instruction. Then the teacher has the opportunity to encourage them to attempt the diagnostic test, practice test, or post-test with their newly acquired skills.

All students experience mastery of each skill in the sequence using this system and method. It is important to distinguish mastery of a skill, as compared to a passing grade. The results of traditional assessments are in the form of a bell shape curve, where only a small fraction of students experience a mastery level score such as 90% to 100%. There is a psychological advantage of achieving a mastery level score on a test and this experience is built-in to the system and method for every student in the class. In fact, it is required for the student to progress to the next skill in the sequence. Although students face challenges in learning new skills, they are rewarded each time they receive a mastery level score. This aspect of the system and method has been instrumental in changing the students' attitudes about their abilities. This is especially noticeable for the subject area of math.

A key element of the system is having the students shout in unison, “I can do it!” where any subject area could be substituted for the word ‘it’. For example, “I can do math!” This slogan instills a belief in their abilities and fosters a team effort within the classroom setting. The way it works is that the students may not believe the slogan the first time they say it. Yet they are taught to say it anyway because repeating it leads to believing it, which is easier to do with a group. The system and method ensures that the students are successful before progressing through the sequence of skills. Their successes are proof that the slogan is true which makes “I can do it!” a reality for them. Gradually, the students shout the slogan with more conviction, which is very rewarding for the teacher.

Teachers have the opportunity to share with the students' parents their child's ability to be successful when they demonstrate mastery of a skill, which cultivates a supportive learning community for the student.

All student work is electronically graded using assisted-response questions and a computer software program to record all the test results. The system and the method add utility to the software to significantly enhance the learning ability of the students. In fact, the unique application of the software is a critical feature of the present invention. This application fully takes advantage of the computer's ability to grade large volumes of student work and create detailed reports for the teacher. It also monitors the exact position of each student in the skill sequence at any point in time and identifies the next step for the student in the system using the method. This helps the teacher manage a large class of students and helps the students advance more rapidly.

The complete and detailed documentation of student work allows the teacher to analyze the progress for every student in the class on each skill at any point in time. This redirects teacher resources from time allocated for administrative duties, like grading, to instructional time. Increased teaching time is directly related to increased student learning.

Students are tested on a daily basis using this system and method and given regular practice with test taking strategies. Therefore, they are accustomed to this process, which minimizes and/or eliminates their test anxiety. As a result, the assessment is more accurate at pinpointing their deficient skills, as opposed to assessing their test taking ability.

The system and method allow the teacher to be more efficient and effective using the same resources, which is highly desirable for people in the profession.

The system and method are applicable to any subject area where learning is enhanced by a sequential learning process, which demonstrates the utility of the system and method. It allows the teacher to determine the scope and sequence and the mastery criteria in order for the students to progress through the curriculum.

The teacher may adjust the mastery criteria to meet the accommodations of students with special needs, which demonstrates the flexibility of the system and method.

Those of ordinary skill in this art will realize from reading this specifications and claims that they will find many ways to utilize this invention to enhance the learning skills of students in small and large classroom settings.

### BRIEF DESCRIPTION OF DRAWINGS

FIG. 1—Flow chart describing the system and method.

FIG. 2—Lesson Sign-Up Sheet

FIG. 3—Correction Sheet

FIG. 4—Graph of Progress in Content Area Ability

FIG. 5—An Example of Graph of Target and Progress in Mastery of Skills in the math content area

FIG. 6—Instructional Aide Sign-Up

FIG. 7—An example of a practice log in the math content area.

### DETAILED DESCRIPTION OF THE INVENTION

The applicant contemplates that the best mode of the present invention is to use individualized instruction in a classroom setting. This is of particular importance where the students in the group have a widely varying range of skills in a content area.

The classroom is outfitted with a minimum of two computers, a method of electronically capturing the data (For example, a scanner.), and a laser printer which are networked to implement the system and method of individualized instruction in a multi-student classroom setting. The students' names are entered into the appropriate computer software, where all of the details of their assessments are recorded as part of the management system. The unique application of the software is a critical feature of the system, which is described in the flow chart.

The teacher selects the scope and sequence of skills from the reference library in the computer software program. The students must master each skill sequentially based on the mastery criteria set by the teacher. The higher the mastery criterion is set on the assessments, the more likely students will retain their new skills in long term memory. It also improves student self esteem to receive a passing score of 90% to 100% on a new skill.

Part of the teacher's resources will be two color-coded binders, where the color is used as a means to facilitate the use of the binder. The first binder contains instructions for lesson delivery for every skill in the sequence determined by the teacher. There is one page per skill in the binder and they are sequentially numbered to match the skill number in the computer system. The second binder contains sample questions with an answer key for every skill in the sequence determined by the teacher. There is one page per skill with several questions and the pages are numbered sequentially to match the skill number in the computer system.

The students are initially assessed to determine their overall skill level using criterion referenced and/or norm referenced diagnostic tests. These are standardized tests which are used for the purpose of creating a baseline skill level for each student in the class. They are also administered at regular intervals during the school year in order to monitor the students' progress using the system and method.

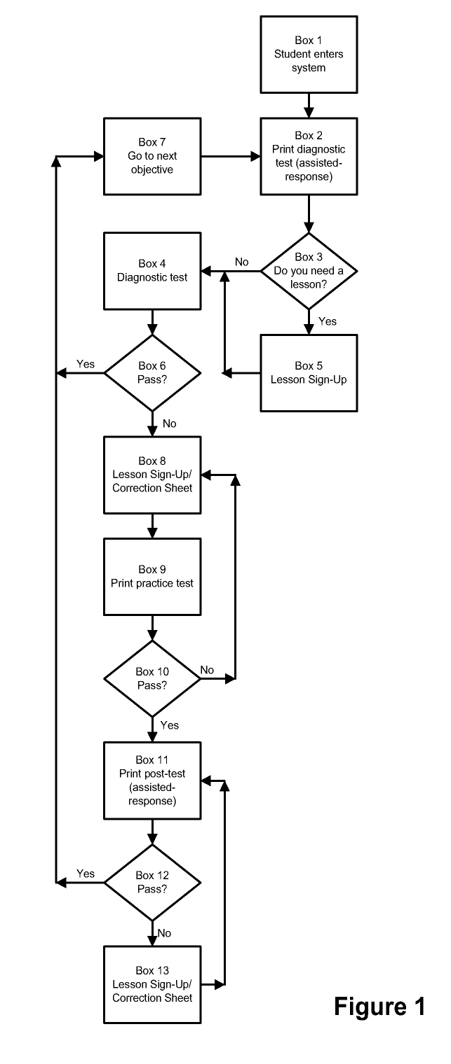

The students are trained in the procedural flow shown in the flowchart in FIG. 1. They learn common test taking strategies, such as interactive editing, process of elimination, and best guess choices. For example, if you were using an electronic scanner to capture the data, then the students are shown how to transfer their answers for the assisted-response questions onto a scanner card. All student responses are compared to reference responses by the computer software. This allows the teacher to utilize resources for instruction, as opposed to grading student work.

The students are trained as a group to shout the slogan, “I can do it!” at the beginning of each class. There may be a competition between classes to see who can do it the loudest. This positive attitude training is essential to the system and method. First the students say the slogan and as they say it they hear it magnified as a chorus. Secondly, they experience success when they master their first skill, which reinforces the slogan. This is followed by repeating the cycle of saying it, hearing it, and doing it. As the school year progresses the students accumulate one success after another and it becomes a self-fulfilling statement.

Each time a student's data on a particular skill test is electronically captured by the computer, a report is generated by the software that details the student's performance on the diagnostic test. The teacher and/or the student can readily identify the incorrect responses and the percentage indicates the extent of the skill deficiency. For example, a student who answers 8/10 correct may not pass the mastery criteria if it is set to 90%. This score indicates minor misconceptions on the skill and the teacher has the opportunity to clarify this using individualized instruction. For example, there are one or more algorithms in the application of math. If the student does not understand all of the algorithms, then it is unlikely they will demonstrate mastery on the diagnostic test. In the application of math, these results would prompt the teacher to have the student show how he/she is solving the problem. A score of 8/10 could also suggest that the student needs a lesson on test taking strategies.

If a student has less than 80% correct, then it is likely that they have more serious misconceptions about the skill. In this case, the teacher would give a lesson that leads to understanding of the fundamental concept before modeling the skill. The teacher uses the Lesson Binder which has conceptual descriptions of the skill and methods or problem solving strategies for constructing solutions. The teacher also uses the Sample Question Binder which has several practice questions with assisted-response solution choices for guided practice and to assess the student's understanding of the new skill. This is important before having the student attempt a diagnostic, practice, or post-test. The Lesson Binder and the Sample Question Binder are easily accessible to the teacher and the format makes it easy to change the sequence and/or add or remove skills. It also makes it very easy for a volunteer to instruct a student by following the steps in the lesson.

The student may master the skill after a single lesson. The system and method is designed to accommodate this student as well as the student who requires repeated lessons on any given skill in the sequence. Each time the student receives a lesson the teacher is reinforcing the concept.

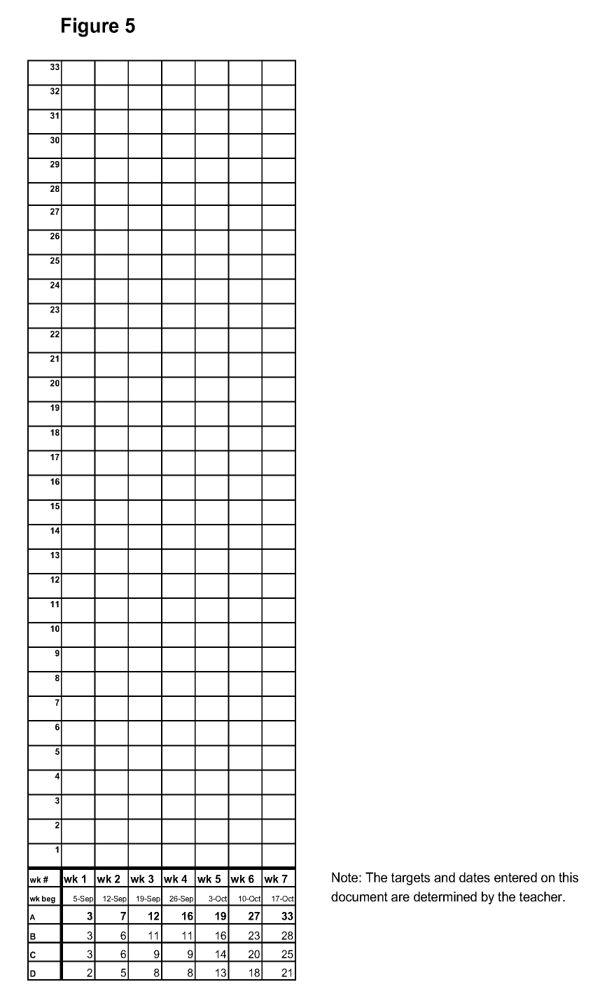

Students use a graph called “Target and Progress in Mastery of Skills”, an example of a math application is shown in FIG. 5, to plot the number of skills they master as a function of time. They are given instruction on how to compare their actual number of skills mastered to the target number set by the teacher. This is used as a motivational tool to encourage the students to reach their goal.

Students are taught to organize their work in a 3-ring binder because the system and method result in a high volume of printed work. The student finds the increasing size of their binder impressive and this gives them a sense of real accomplishment.

The following description of the procedural flow of the system and method is schematically shown in FIG. 1. Each step is put into a box and given a number. Every student begins (Box 1) with the first skill in the sequence, which is the initial objective in the computer program. The teacher or the computer operator prints a diagnostic test (Box 2) on the initial objective for every student with randomly generated, assisted-response questions. Hence, each student has a unique test and they all begin at the same starting point.

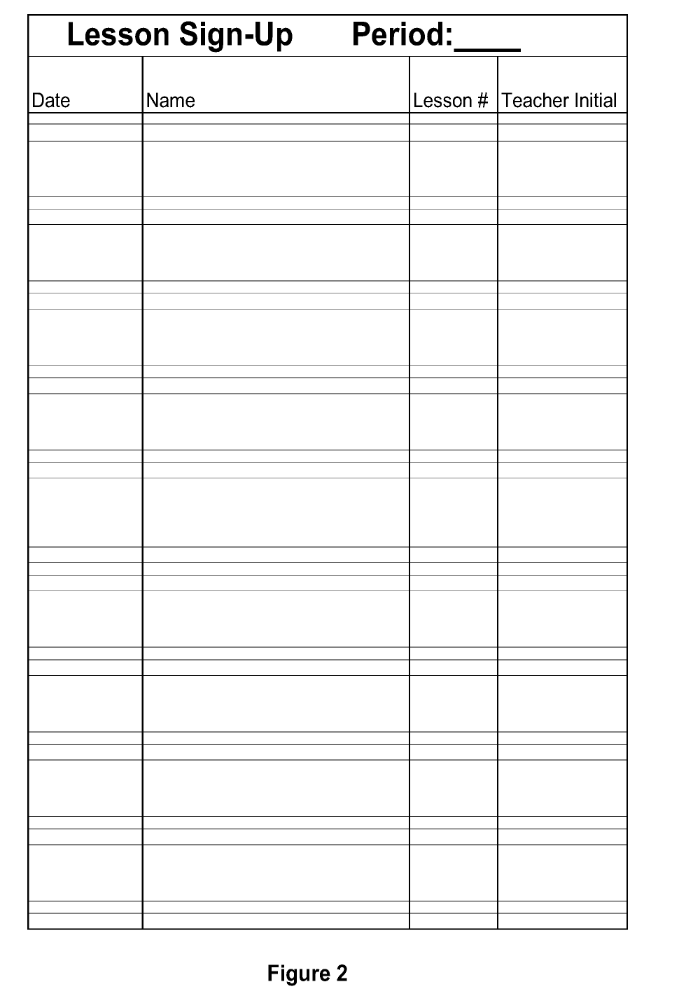

The student makes the decision (Box 3) as to whether she/he needs a lesson before attempting the diagnostic test. In the event that the student elects to attempt the diagnostic test, refer to (Box 4) on the flowchart. If the student is not sure how to answer the question, he/she signs up for a lesson (Box 5). The student uses the lesson sign-up sheet, shown in FIG. 2, to sign-up for individualized instruction. They enter the date, the objective number, and their name. The students are called in the order they are signed up for a lesson with the teacher or a volunteer (if available) who works in the classroom. This is especially useful in a situation where there is more than one teacher or volunteers in the classroom giving lessons.

The system and method use the teacher and volunteers (if available/needed) to give individualized instruction for a large number of students. There is a place on the sign-up sheet for teacher initials to indicate that the student has received a lesson. The lesson sign-up sheet acts as a control document and provides a permanent record of all the lessons the student has received on a particular skill. The teacher may use this information in conjunction with assessment results to monitor student progress and the effectiveness of a particular lesson.

The students work independently to answer the question on the diagnostic tests (Box 4). Once the student completes the test, their responses are electronically captured by the computer, for example, by the use of a scanner and a scantron card. The computer compares the student response to a reference response and indicates if the student has met the mastery criteria (Box 6). A report is automatically printed with the details of incorrect responses and listing correct responses for comparison.

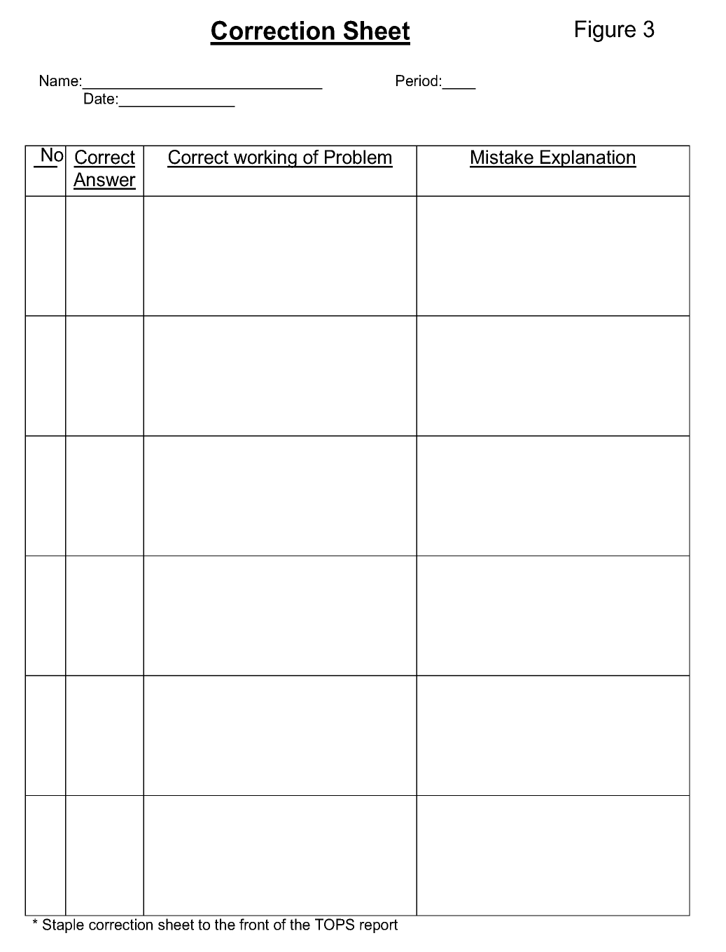

If the student has not passed, then they get the correction sheet, FIG. 3, stapled to their work. They can then go back to their desk and work on the incorrect answers as identified by the computer on the correction sheet while they wait for the individualized lesson. Students also have the option to use the Lesson Binder or the Sample Question Binder, which provide conceptual descriptions of the skill, methods or strategies for constructing a solution, and several practice examples with an answer key, as resources to make their corrections. An example of a Correction Sheet is shown in FIG. 3. This document organizes the student's workings which are very useful for clarifying misconceptions on the skill and helps the teacher focus the instruction.

If the student passes the mastery criteria, then the student progresses to the next objective (Box 7) in the sequence. They are given a new diagnostic test (Box 2) with randomly generated, assisted-response questions on the next skill. They return to their desk to work independently on the test and/or sign up for a lesson (Box 3), as described above. Hence, the feedback-loop-cycle as described in SUMMARY OF THE INVENTION.

It is important to note that every student experiences the success of mastery each time they progress to the next skill in the sequence. This is not true for traditional whole group instruction even with the aid of scaffolding.

If the student does not pass the first objective, then they enter their name on the lesson sign-up sheet (Box 8). After the student receives a lesson on the deficient skill, then the computer operator prints a practice test (Box 9) to assess the student's understanding of the new lesson. If the student passes (Box 10) the mastery criteria for the practice test, then the computer operator prints a post-test (Box 11). If the student does not pass (Box 12) the post-test, the student must enter their name (Box 13) on the lesson sign-up sheet to re-enter the individualized instruction portion of the loop at (Box 11).

However, if the student does not pass (Box 10) the practice test, then they re-enter their name (Box 8) on the lesson sign-up sheet to re-enter the instruction portion of the loop at (Box 8). Similarly, the student must pass (Box 12) the post-test in order to progress to the next objective in the sequence (Box 7). If the student does not pass (Box 10) the practice test after a number of attempts, the teacher can intervene the cycle using alternative teaching strategies for the particular skill.

One can see from the flowchart, shown in FIG. 1 that students who have prior knowledge of the skills in the sequence demonstrate mastery and quickly move through the sequence. The rate of progress slows only when the student encounters a deficient skill. The student's ability to acquire the new skill is dependent on many factors. One should note that using the system and method allows the teacher to focus instruction time on clarifying misconceptions and teaching new skills. As a result, the rate of growth is maximized for the students in the subject area.

The computer system keeps track of how many objectives a student has mastered. It is advisable to set a daily target for the student as to the number of objectives they must attempt to master each day, e.g. one per day. This information is kept track of by the student, by plotting the data on their Target and Progress in Mastery of Skills graph, where an example using the math content area is shown in FIG. 5.

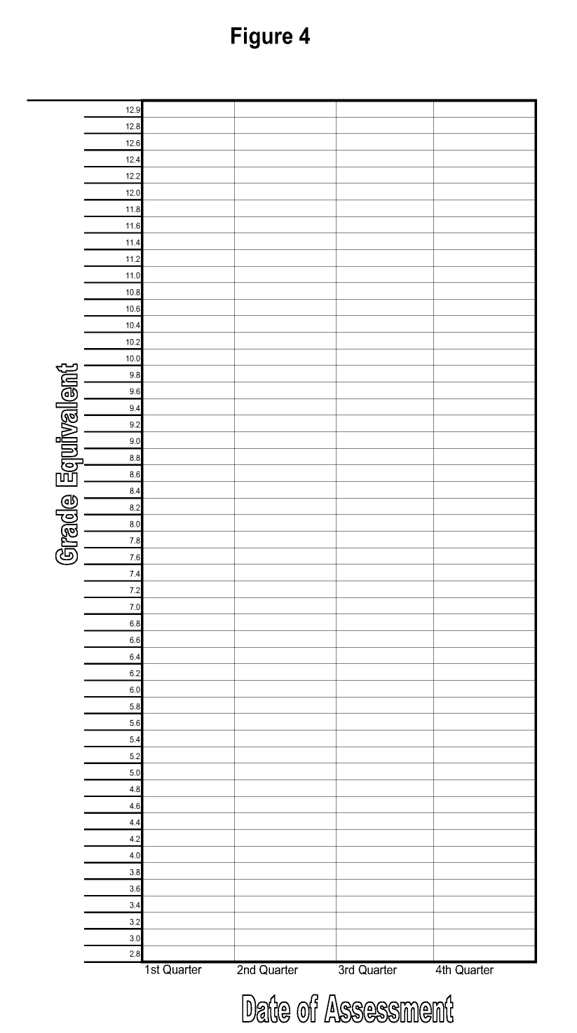

FIG. 4 is an example of a Progress in Content Area Ability graph, where the inventor has applied the system and method in the math content area. All students are initially assessed using standards based diagnostic tests to establish a baseline of their skill level. If the year is divided into quarters, then these standardized tests would be repeated each quarter to give sufficient time to accurately be able to identify some level of growth.

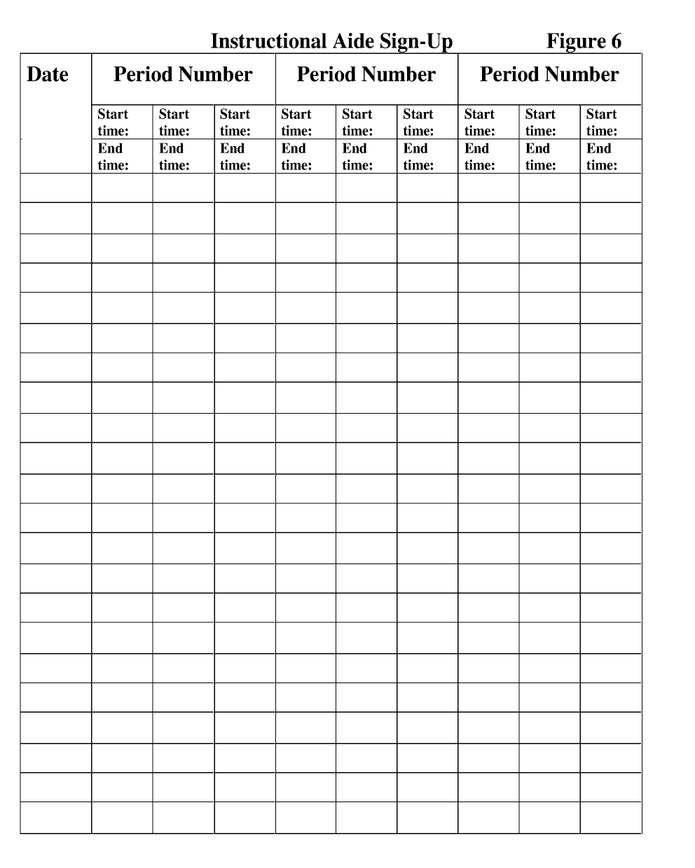

FIG. 6 is an Instructional Aide Sign-Up sheet to be used in a multi-student environment, where some students will perform better than others. If students reach their target set by the teacher, then they have the incentive and are given the opportunity to operate the computer. However, it is envisioned that further software programming would eliminate the need for computer operators. In this case, the program would automatically print the necessary document depending on the students' progress and their specific point in the feedback-loop-cycle of the flowchart. This adds utility to the computer software, which enhances the rate of student learning.

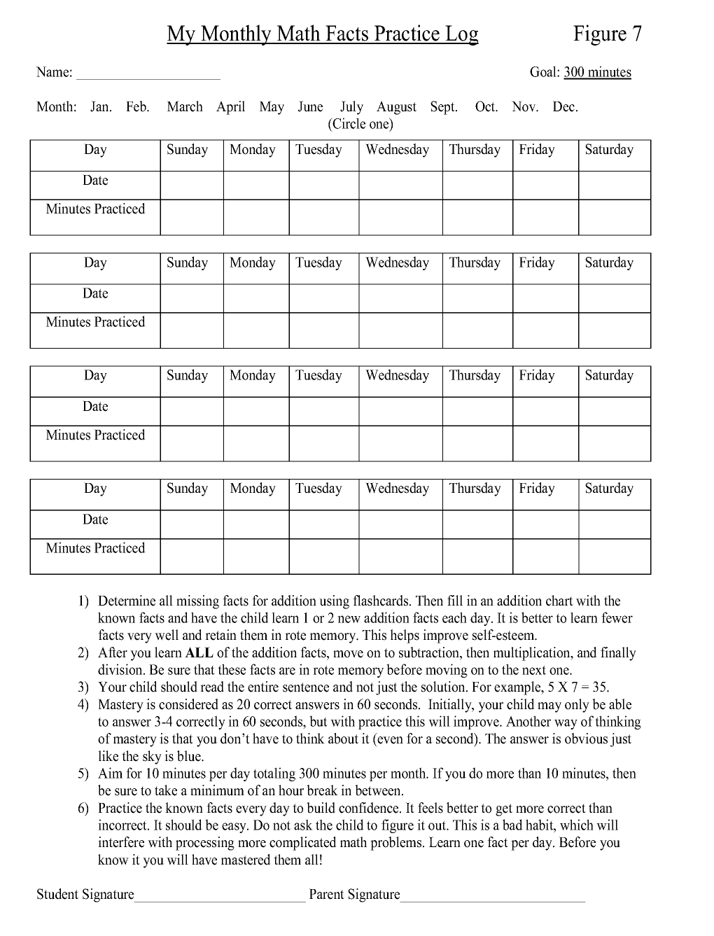

FIG. 7 is an example of a practice log used by the inventor in the math content area called Monthly Math Facts Log. It is designed for parents or guardians to use flashcard with students and log the minutes practiced. This is supplementary to the system and method of the present invention and was used successfully by the applicant in the practice of a seventh grade math class. It is necessary to note that the mastery of basic facts such as addition, subtraction, multiplication, and division is a very important underlying skill subset for success in this or any other math curriculum. This is an example of applying the system and method in the math content area. It would also be applicable to a reading log, which would support a literacy based learning system.

### Example of the System and Method Applied to Mathematics

The applicant has actually reduced the present invention to practice by teaching a seventh grade math class in accordance with the above-described system and method. There were 30 students in the class and 1 to 2 volunteers giving individualized lessons during each class. The applicant determined the scope and sequence of math skills in the curriculum. Students were initially assessed using STAR Math diagnostic tests and found to be an average of two grades below their grade level. The students exhibited math skill levels ranging from as low as first grade to as high as seventh grade. This is very significant following the enactment of the No Child Left Behind Act, where schools are required to show growth in student skill levels. The students in the seventh grade math class were trained in the system and method at the beginning of the school year. All students began working on the same skill in the sequence, but they all learned at different rates depending on their unique skill profiles. So that during any school day after the first day of class they were learning different skills in the sequence. All the students were learning the exact skill they needed to progress through the sequence during each class day. Students that were absent picked up right where they left off in their work from the previous day. At the end of the school year, the STAR Math diagnostic tests were repeated and the average growth in math skill levels for all the students was three years during one school year.

What is claimed is:

1. A process of simultaneously teaching a large number of students with a wide range of skills with an individualized instruction program comprising the steps of: inputting into a computer system, all of the details of assessments of all students in the class by student name; inputting into the computer system, designations of a plurality of lessons, selected by the teacher to be taught, each lesson including educational material; inputting into the computer system, curriculum information comprising an indication of which of the lessons are prerequisite lessons for subsequent lessons; inputting into the computer system, student information for two or more students, including indications of their levels of competence with respect to the educational material of one or more of the lessons entered into the computer system; the computer system producing a lesson plan for the individual student to follow in sequence to best advance the student's mastery of the curriculum at the fastest possible rate for the individual student; the student signs up to receive the lesson on a lesson sign up sheet; after the student receives the lesson, the student takes an individualized test provided by the computer system; the student's answers are electronically captured into the computer system by the use for example of an electronic scanner and scantron card; the computer grades the test and provides the student with a print out of the scores and correct answers for incorrect responses of the student for comparison; if the student passes then the next lesson is indicated to the student; and if the student did not pass then the correction sheet information is provided to the student.

2. A process of simultaneously teaching a large number of students with a wide range of skills with an individualized instruction program, according to claim 1, wherein the student takes diagnostic tests after mastering each particular lesson.

3. A process of simultaneously teaching a large number of students with a wide range of skills with an individualized instruction program, according to claim 2, wherein the student scans the diagnostic test answers into said computer system so that the computer system can grade the tests, record the scores, and generate a report identifying the incorrect responses of the individual student with the correct responses for comparison

4. A process of simultaneously teaching a large number of students with a wide range of skills with an individualized instruction program, according to claim 1, wherein the teacher determines the mastery criteria for each lesson in the computer system for passage of the student onto the next lesson.

5. A process of simultaneously teaching a large number of students with a wide range of skills with an individualized instruction program, according to claim 4, wherein the teacher sets the mastery criteria for each lesson in the computer system at 90% for passage of the student onto the next lesson.

6. A process of simultaneously teaching a large number of students with a wide range of skills with an individualized instruction program, according to claim 1, wherein the teacher after observing a number of failed attempts to pass a lesson can intervene using alternative teaching strategies for the particular skill to push the student along the sequence of lessons faster for that student.

7. A process of simultaneously teaching a large number of students with a wide range of skills with an individualized instruction program, according to claim 1, wherein the computer system aids the teacher to allow the teacher to expend most of their time on individualized instruction program to get each student past the difficult hurdles for that student in the program at the fastest possible rate.

8. A process of simultaneously teaching a large number of students with a wide range of skills with an individualized instruction program, according to claim 1, wherein the computer system keeps track of how many lessons each student has mastered and the number of attempts for each day to provide a log report to the teacher on each student for all students in the class for each day of individualized instruction program by date.

9. A process of simultaneously teaching a large number of students with a wide range of skills with an individualized instruction program, according to claim 1, wherein each student uses a notebook to build a file of the student's progress to impress the student with the progress that the student has made.

10. A system for managing the process of simultaneously teaching a large number of students with a wide range of skills with an individualized instruction program comprising: a networked computer system including two or more computers, a method of electronically capturing a student's answers, by the use for example of an electronic scanner, and a printer to implement a method of individualized instruction to a large number of students in a class; computer software on said networked computer system to assist the computer system in the implementation of the individualized instruction program; means for inputting into said computer system of all of the details of assessments of all students in the class by student name; means for inputting into said computer system, designations of a plurality of lessons, selected by the teacher to be taught, each lesson including educational material; means for inputting into said computer system, curriculum information comprising an indication of which of the lessons are prerequisite lessons for subsequent lessons; means for inputting into said computer system, student information for two or more students, including indications of their levels of competence with respect to the educational material of one or more of the lessons entered into said computer system; and said computer system having a means for producing a lesson plan for each individual student to follow in sequence to best advance the student's mastery of the curriculum at the fastest possible rate for the individual student.

11. A system for managing the process of simultaneously teaching a large number of students with a wide range of skills with an individualized instruction program, according to claim 10, further comprising: a means for the individual student to take diagnostic tests after mastering each particular lesson.

12. A system for managing the process of simultaneously teaching a large number of students with a wide range of skills with an individualized instruction program, according to claim 11, further comprising: a means for the individual student to have the answers electronically captured into said computer system.

13. A system for managing the process of simultaneously teaching a large number of students with a wide range of skills with an individualized instruction program, according to claim 12, further comprising: a means for said computer system to grade the tests, record the scores, and generate a report identifying the incorrect responses of the individual student with the correct responses for comparison.

14. A system for managing the process of simultaneously teaching a large number of students with a wide range of skills with an individualized instruction program, according to claim 10, further comprising: a means for assessing at each stage of the student interactions with said computer system, the progress of the student compared to the goals set by the teacher and reporting same to the teacher for all students every day.

15. A system for managing the process of simultaneously teaching a large number of students with a wide range of skills with an individualized instruction program, according to claim 10, further comprising: a means for the teacher to set the mastery criteria for each lesson in the computer system for passage of the student onto the next lesson.

16. A system for managing the process of simultaneously teaching a large number of students with a wide range of skills with an individualized instruction program, according to claim 15, further comprising: a means for enabling the teacher to set the mastery criteria for each lesson in the computer system at 90% for passage of the student onto the next lesson.

17. A system for managing the process of simultaneously teaching a large number of students with a wide range of skills with an individualized instruction program, according to claim 10, further comprising: a means for the teacher after observing a number of failed attempts to pass a lesson can intervene using alternative teaching strategies for the particular skill to push the student along the sequence of lessons faster for that student.

18. A system for managing the process of simultaneously teaching a large number of students with a wide range of skills with an individualized instruction program, according to claim 10, further comprising: a means for the computer system to aid the teacher to expend most of their time on individualized instruction program to get each student past the difficult hurdles for that student in the program at the fastest possible rate.

19. A system for managing the process of simultaneously teaching a large number of students with a wide range of skills with an individualized instruction program, according to claim 10, further comprising: a means for the computer system to keep track of how many lessons each student has mastered and the number of attempts for each day to provide a log report to the teacher on each student for all students in the class for each day of individualized instruction program by date.

20. A system for managing the process of simultaneously teaching a large number of students with a wide range of skills with an individualized instruction program, according to claim 10, further comprising: a computer controlled system of paper forms to organize each individual student on the implementation of the system for the entire class of students.

21. A system for managing the process of simultaneously teaching a large number of students with a wide range of skills with an individualized instruction program, according to claim 10, further comprising: notebooks for each student to build a file of the student's progress and to impress the student with the progress that the student has made.
